(19) United States
(12) Patent Application Publication
(10) Pub. No.: US 2020/0074417 A1
(43) Pub. Date: Mar. 5, 2020

(54) Configuration Platform

(71) Applicant: Venuetize LLC, Tampa, FL (US)

(72) Inventor: Nimish Shrivastava, San Marcos, CA (US)

(21) Appl. No.: 16/120,388

(22) Filed: Sep. 3, 2018

(51) Int. Cl. G06Q 20/02

(52) U.S. Cl. CPC G06Q 20/027

(57) ABSTRACT

System, method, and a computer program product that configure a platform are provided. A platform receives a configuration for multiple items to be included in the platform. The platform also receives a configuration that associates a first account with the first item from the multiple items and a second account with the second item in multiple items. The platform also receives a configuration that associates a first gateway with the first account and a second gateway with the second account. The platform is configured to associate the first item with the first gateway and the second item with the second gateway.

### TECHNICAL FIELD

The disclosure generally relates to computerized platforms, and specifically to a configuring processing of the platform using rules.

### BACKGROUND

Conventional computing platforms are single solutions for all users. For example, users using computing devices may access platform interface, and use the interface to upload data to the platform, make the data available to other users, and retrieve, manipulate, and display data. Such platforms however, do not provide users with flexibility for configuring the platforms to match users' needs. Accordingly, what is needed are systems and methods that dynamically configure processing of a computing platform to meet requirements of various users based on rules configured on a client device.

### SUMMARY OF THE DISCLOSURE

Embodiments describe a system, method, and computer program product for configuring a platform that executes on a server. Configuration that associates a plurality of items with one or more modules is received. Configuration that associates a first account with the first item in the plurality of items, and a second account with a second item in the plurality of items is also received. Configuration for a first gateway to be associated with a first account and a second gateway to be associated with the second account is received. The configuration for the plurality of items, the first and second account, and the first and second gateway may be received from a configuration interface. The platform is configured to associate the first item with the first account and the first gateway and the second item with the second account and the second gateway.

Embodiments also describe a system, method, and computer program product for configuring a platform such that the first item to be associated with a first module of the one or more and a second item to be associated with the second module of the one or more modules.

Embodiments also describe a system, method, and computer program product for configuring the first item to be associated with a first module and the second item to be associated with the first module.

Embodiments also describe a system, method, and computer program product that receive a rule for configuring one or more values on the platform and assign an amount to the one or more values based on the rule.

Embodiments also describe a system, method, and computer program product that receive instruction for configuring one or more values based on a profile, identify a property in the profile, and configure the one or more values based on the property in the profile.

Embodiments also describe a system, method, and computer program product that receive a first token and a second token from the first gateway, wherein the first token and the second token are associated with information of a user associated with a profile, select one of first token and the second token to process the first item and the second item, and process the first item and the second item using the selected token.

Embodiments also describe a system, method, and computer program product that process the first item using the configured platform.

Embodiments also describe a system, method, and computer program product that receive a transaction associated with the first item, adjust the transaction using one or more values previously configured using on or more rules, identify the first account using the first item, identify the first gateway using the first account, and process the transaction using the first account and the first gateway.

### BRIEF DESCRIPTION OF THE DRAWINGS

FIG. 1 is a block diagram of a system environment where embodiments can be implemented.

FIG. 2 is a block diagram of a platform, according to an embodiment.

FIG. 3 is a flowchart of a method for configuring a platform, according to an embodiment.

FIG. 4 is a flowchart of a method for configuring a mobile wallet module, according to an embodiment.

FIG. 5 is a block diagram of an application, according to an embodiment.

FIG. 6 is a flowchart of a method for processing a transaction using a configured platform, according to an embodiment.

FIG. 7 is a block diagram of a computer system suitable for implementing one or more components in FIGS. 1-6, according to an embodiment.

Embodiments of the disclosure and their advantages as depicted by the figures described above are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

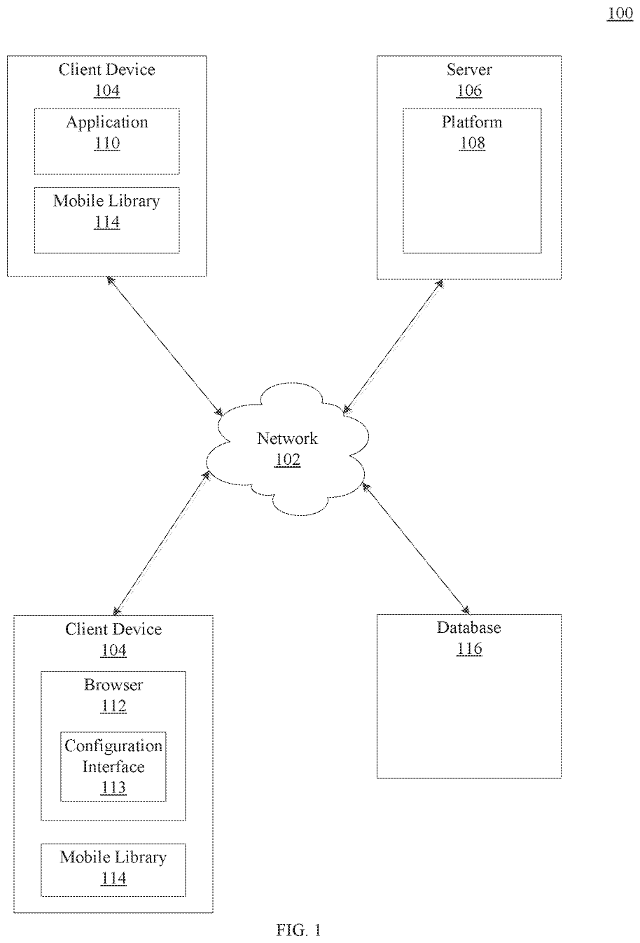

FIG. 1 is an exemplary system 100 where embodiments can be implemented. System 100 includes a network 102. Network 102 may be implemented as a single network or a combination of multiple networks, including local area networks (LANs), wide area networks (WANs) such as the Internet or the Word Wide Web, metropolitan area networks (MANs), etc. Network 102 may also include one or more of intranets, landline networks, wireless networks, and/or other appropriate types of networks.

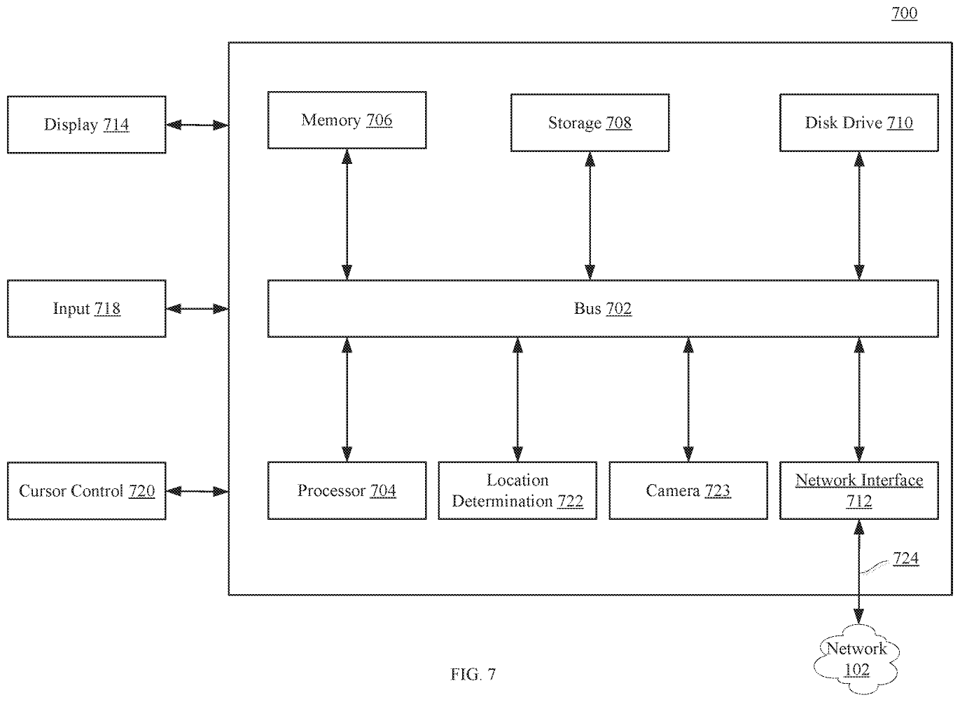

Example system 100 includes one or more client devices 104. Client device 104 may be a portable or non-portable electronic device under control of a user, and configured to transmit, receive, and manipulate data over network 102. Example client device 104 may include a smartphone, a tablet, a laptop computer, a wearable electronic device, eyeglasses that can be incorporated into an electronic device, an electronic watch, etc. Client device 104 may also include and execute operating systems, such as iOS, Android, Unix, Linux, Microsoft Windows, etc. In an embodiment, one or more components that may be included in client device 104 are described in detail in FIG. 7.

In an embodiment, system 100 includes a server 106. Server 106 may be an application server, a web server, a cloud server, etc., that provides data and information to client device 104. In an embodiment, server 106 may store data, applications, instructions, etc. Server 106 may also provide data, applications, instructions, etc., to client device 104. In an embodiment, one or more components that may be included in server 106 are described in detail in FIG. 7.

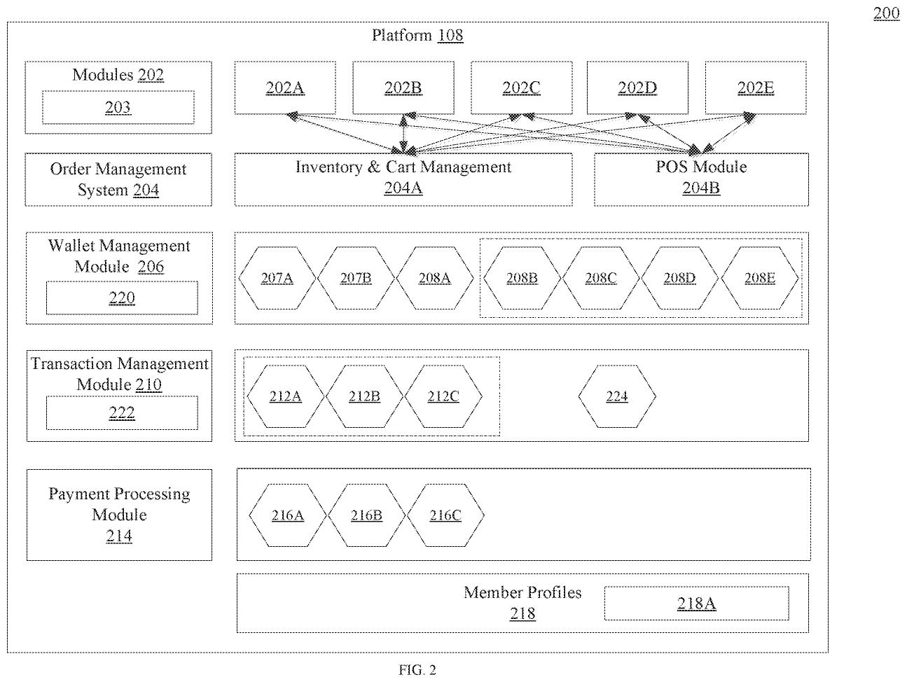

In an embodiment, server 106 may host a platform 108. Platform 108 may be a collection of one or more services that may be accessed to by platform 108 or execute within platform 108. In an embodiment, access to services within platform 108 may be configured using one or more client devices 104. In some embodiments, platform 108 may be an electronic commerce platform and is discussed in more detail in FIG. 2 below.

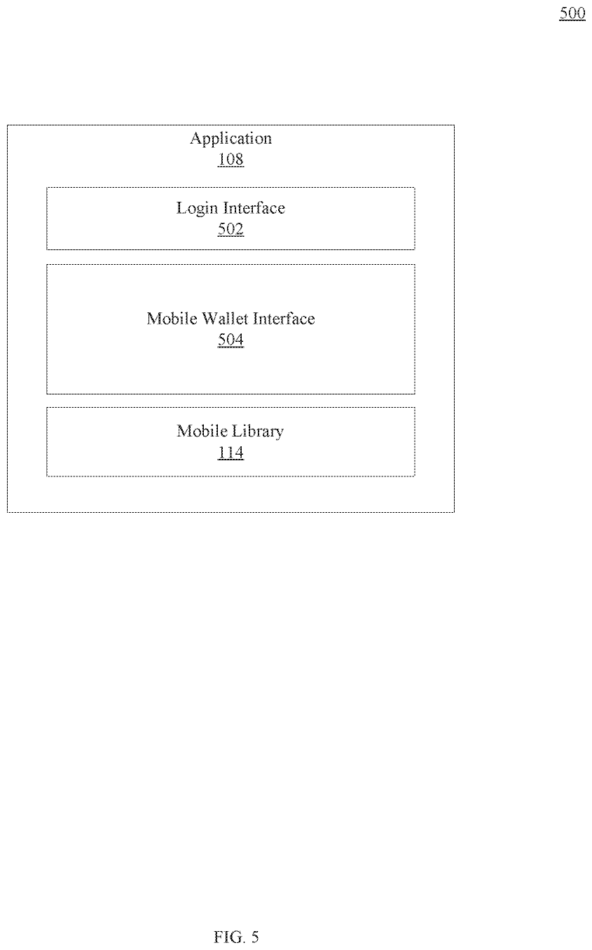

In some embodiments, system 100 may include one or more applications 110. Application 110 may be a software application designed using software development kit (“SDK”), Java, C++, Objective C, Swift, Kotlin, JavaScript, Python, CSS, PHP, Rube, etc., or any combination thereof. In some embodiments, application 110 may be downloaded to client device 104 from server 106, pre-installed on client device 104, installed on the client device 104 using portable memory storage devices, such as compact disks or a thumb-drives, etc. Once installed, application 110 may execute on client device 104 and communicate with platform 108. The communication may retrieve data from platform 108 for display on application 110, upload data to platform 108, etc. In some embodiments, the communication may use a Hypertext Transfer Protocol (“HTTP”) or JavaScript Object Notation (“JSON”) format and protocol. Application 110 is discussed in detail in FIG. 5.

In some embodiments, client device 104 may also include a browser 112. Browser 112 is an application executing on client device 104 that retrieves and presents information resources that are stored on server 106 connected to the Internet or the World Wide Web. An information resource may be identified by a uniform resource identifier (URI) or a uniform resource locator (URL) and may be a webpage, an image, a video, or another type of content. In some embodiments, information may be downloaded from platform 108 and displayed on client device 104. In other words, browser 112 may also be used to display data and manipulate data instead of application 110.

In an embodiment, application 110 and platform 108 may process transactions on behalf of the operator of application 110. Unlike conventional platforms, platform 108 may be configured to process transactions based on one or more configurable rules. The one or more rules indicate items, such as products and services that may be included in the transactions, as well as specific transaction processing for each product or service.

In an embodiment, platform 108 may be configured using a configuration interface 113. Configuration interface 113 may be a resource downloaded from server 106 or from platform 108. Configuration interface 113 may display one or more configuration options and may receive one or more selections for the configuration options. Configuration interface 113 may then use browser 112 to transmit the configuration information to platform 108. Once platform 108 receives the configuration information, platform 108 may use the configuration information to determine the data that may be displayed on application 110, as will be discussed in detail in FIG. 2.

In an embodiment, a mobile library 114 may also be downloaded or otherwise installed on client device 104. Mobile library 114 may store instructions that may be used by application 110 or browser 112. In an embodiment, mobile library 114 may also communicate with platform 108. The communications may provide platform 108 with parameters that may be retrieved from client device 104. Example parameters may include the location of client device 104, the type of client device 104, the operating system that executes on client device 104, etc. In an embodiment, mobile library 114 may also communicate with third-party providers, such as payment gateways (described below), in order for the user set up accounts with the payment gateway so that platform 108 may process the transactions.

In some embodiments, platform 108 may store and retrieve data from a database 116. Database 116 may be a collection of tables, views, schemas, etc. Database 116 may be configured to store organized data in memory storage, such as one of memories described in detail in FIG. 7. Example data may include configuration information in platform 108, configuration rules, data, member profiles, etc.

FIG. 2 is a block diagram 200 of an example platform 108, according to some embodiments. As discussed above, platform 108 may be an electronic commerce platform.

In an embodiment, platform 108 may be configured by sellers, such as venue owners and used by buyers or members to conduct one or more transactions. Unlike conventional platforms that simply provide a medium for buying and selling products over a network, platform 108 may be configured by each seller to provide different types of products and services for sale, issue promotions, perform product or service specific processing, etc. Accordingly, configuration interface 113 may receive instructions from each seller to configure platform 108 to provide goods or services specific to that seller, configure payment gateways that may process the transactions for the goods and service, set up merchant accounts specific to one or more products or services, provide promotions that are tailored to each buyer, provide personalized experience for each buyer, etc. In this way, platform 108 may process the same product or service for one seller differently from how platform 108 may process the same product or service for another seller.

In an embodiment, platform 108 may include or have an interface with one or more modules 202. Modules 202 may be software programs that may be included in or accessed by platform 108. Each module 202 may be configured to provide a type of a product or a service. Example module 202 may be an event tickets module 202A. The event tickets module 202A may be configured by a seller, who may be a venue owner, using configuration interface 113 to provide one or more tickets to buyers to one or more venues offered by venue owner. Example tickets may be tickets to sport events, concerts, shows, etc. In another example, event tickets module 202A may provide tickets for a specific sporting event, while another event tickets module 202A may provide tickets to a different sporting event. Another example module 202 may be a parking pass module 202B. Parking pass module 202B may be configured by a seller using configuration interface 113 to provide consumers with one or more parking passes, venue transportation passes, seasonal parking passes, etc. Another example module 202 may be a betting module 202C. Betting module 202C may be configured by a seller using configuration interface 113 to place bets at one or more events, such as horse racing, greyhound racing, etc. Another example module 202 may be a food and beverages module 202D. The food and beverage module 202D may be configured by a seller using configuration interface 113 to provide access one or more food items and/or one or more beverage items. Yet another example module 202 may be a merchandize module 202E. Merchandize module 202E may be configured by a seller using configuration interface 113 to provide merchandize products, etc.

In an embodiment, additional modules 202 may be added to platform 108 or existing module 202 may be removed from platform 108.

As discussed above, platform 108 may configure products or services that may be included in modules 202. To configure products or services, a configuration interface 113 may receive instructions from a seller that identify products or services that may be available to buyers via platform 108. The instructions may select a product or a service from a list of available products or services or include the identified product or service. In an embodiment, the instructions may also select one of module 202A-E that may be used to purchase the product or a service. In this way, configuration interface 113 may configure the products or services for each module 202 in modules 202A-E. Once configuration interface 113 receives the instructions the configuration interface may transmit the instructions to platform 108. In an embodiment, platform 108 may receive the instructions and assign products or services to one or more modules 202.

In an embodiment, platform 108 may generate profiles 203 for products or services identified using configuration interface 113. Profiles 203 may store information about products or services. Example information may be product or service type, purchase price, product or service information, etc. Profile 203 may also associate a product or service with module 202 that may sell the product or the service. In some embodiments, there may be a single profile 203 per product of service. In an embodiment, profiles 203 may be stored within modules 202, within memory of server 106 (not shown) discussed in FIG. 7 or within database 116 (not shown).

In some embodiments, platform 108 may interface with an order management system 204. Order management system 204 may be provided by a third-party. In one embodiment, order management system 204 may be installed on the same or different server 106 as platform 108 and may communicate with platform 108 using one or more messages. In another embodiment, order management system 204 may include an application interface that may be stored in mobile library 114 of client device 104 that may communicate using one or more messages with order management system 204 and platform 108 over network 102. In yet another embodiment, order management system 204 may be an executable developed using and SDK and installed in client device 104 that executes application 110.

In an embodiment, order management system 204 may interface with platform 108 to provide an interface to inventory and cart management module 204A and point-of-sale module 204B. In some embodiments, inventory and cart management module 204A may store products or services that a buyer selected from modules 202A-E but has not purchased, store or list transactions for previously purchased products or services, have a notification mechanism that notifies the buyer whether the selected products or services have not been purchased but remain in the memory storage associated with the inventory and cart management module 204A, etc.

In an embodiment, point-of-sale module 204B may provide an electronic point-of-sale for buyers purchasing products or services from one or more modules 202A-E. Point-of-sale module 204B may be included within client device 104 or within application 110, may be a standalone device that may communicate with application 110 that executes on client device 104, may be a hand-held terminal, etc. In some embodiments, application 110 may communicate with point-of-sale module 204B using one or more messages transmitted over network 102. In other embodiments, application 110 may communicate with point-of-sale module 204B using one or more messages transmitted using near field communication (“NFC”) protocols, 2D code scanners, etc. In an embodiment, point-of sale 204B may conduct a transaction initiated by application 110 on behalf of one or more buyers.

In an embodiment, platform 108 may include a wallet management module 206. Wallet management module 206 may process third-party cashless payment tokens 207A and credit and debit card tokens 207B.

In an embodiment, third-party cashless payment tokens 207A may be tokens that were submitted from application 110 and that were generated by a third-party. These tokens may be associated with a transaction for payment of products or services and may be passed to payment gateways, discussed below.

In an embodiment, credit card and debit card tokens 207B may be tokens transmitted from application 110 that are associated with the transaction or that may be stored within platform 108 for subsequent transactions made by the buyer associated with credit card and debit card tokens 207B.

In an embodiment, wallet management module 206 may include one or more values 208, such as 208A-E. Example values 208 may be stored values 208A, loaded values 208B, discount values 208C, transfer values 208D, sponsored values 208E, etc.

In an embodiment, stored value 208A may include a monetary amount funded by a member that may be used to conduct a transaction using platform 108. Example stored value 208A may be a value uploaded to platform 108 that may be stored in a ledger included in platform 108 (not shown). In an embodiment, uploading an amount to be included in stored value 208A to platform 108, and using a credit card or a debit card to pay for the amount may be a transaction between point-of-sale module 204B and platform 108. In an embodiment, platform 108 may access the ledger and transmit stored value 208A for display on application 110 so that the buyer may use the amount in stored value 208 in the transaction.

In an embodiment, loaded values 208B may be monetary values that are provided to a member by a seller, such as a venue owner. For example, an amount stored in loaded value 208 associated with a ticket or an event, one or more properties in member profile 218, or other criteria that may be configured using configuration interface 113. For example, configuration interface 113 may receive instructions from the seller to configure the amount for loaded value 208B. The amount in loaded values 208B may be applied to a transaction. In an embodiment, loaded value 208B may be a long term loaded value or a short term loaded valued. The long term loaded value may be applied to transactions at numerous events, while the short term loaded value may be applied to a transaction over a single event or over a configurable time period during an event. Once the event or the time period expires, wallet management module 206 may remove the amount in loaded values 208B.

In an embodiment, discount value 208C may include promotions, discounts, etc., that are available to buyers on per event, per product, per service or other basis. In an embodiment, configuration interface 113 may receive instructions that configure a value for discount value 208C.

In an embodiment, transfer value 208D may be a monetary value that one buyer may transfer to another buyer. In an embodiment, transfer value 208D may be configured using configuration interface 113 by receiving instructions from the seller. Once transferred the receiving buyer may use the monetary value to purchase a product or a service using application 110. In an embodiment, configuration interface 113 may receive instructions from the seller to configure the amount for transfer value 208D.

In an embodiment, sponsored value 208E may include a value that is offered as a reward for sponsored behavior. For example, sponsored value 208E may indicate that a buyer may receive a discount or a monetary reward if application 110 receives instructions from the buyer to use a credit card associated with a sponsored bank, or if application 110 receives instructions to conduct a transaction for a sponsored product.

In an embodiment, point-of-sale module 204B may apply values specified in values 208A-E to a transaction when application 110 conducts a transaction at point-of-sale module 204B for a purchase of a product or a service.

In an embodiment, platform 108 includes a transaction management module 210. Transaction management module 210 may include one or more merchant accounts 212, such as merchant accounts 212A, 212B, and 212C. In an embodiment, merchant accounts 212 may be configured to be associated with products or services provided by each module. In yet another embodiment, one of merchant accounts 212 may be configured to be associated with a single product or a service. In yet another example, one of merchant accounts 212 may be configured to be associated with product or service information. For example, configuration interface 113 may receive instructions to configure event tickets module 202A to be associated with merchant account 212A. In another example, configuration interface 113 may configure merchant account 212A to be associated with tickets for a concert and merchant account 212B to be associated with tickets to a basketball game.

In an embodiment, platform 108 may include a payment processing module 214. Payment processing module 214 may include an interface to one or more payment gateways 216, such as payment gateways 216A-C. Payment gateways 216 may be PCI DSS (payment card industry data security standard) compliant third-party transaction systems that process transactions from point-of-sale module 204B for merchant accounts 212. Example payment gateways 216 may be Shift 4®, Authorize.net, etc.

In an embodiment, for platform 108 to process transactions using payment gateways 216A-C, a seller may register with payment gateways 216A-C using configuration interface 113. Once registered, configuration interface 113 may securely receive the account number and other payment information of the seller and transmit the information to platform 108. In an embodiment, the information may be securely stored within memory of payment processing module 214, within merchant accounts 212 or in database 116.

In an embodiment, a seller may use configuration interface to associate merchant accounts 212A-C and payment gateways 216A-C. For example, a configuration interface 113 may receive instructions to link merchant account 212A with payment gateway 216B. In another example, a configuration interface within 113 may receive instructions to link merchant account 212B and payment gateway 216C.

In an embodiment, platform 108 may link products or services to merchant accounts 212 and payment gateways using rules 222. Rules 222 may be configured using configuration interface 113 and transmitted to platform 108. Rules 222 may identify a product or a service and associate the product and a service with one of merchant accounts 212 and one of payment gateways 216. As illustrated in FIG. 2, rules 222 may be stored in the memory storage associated with transaction management module 210, with another memory storage associated with platform 108 (not shown), or in database 116.

In an embodiment, platform 108 may store member profiles 218. Member profiles 218 may be profiles associated with buyers that may use one or more services offered by platform 108 and conduct transactions using application 110. Example member profiles 218 may store member properties, such as the name, address, telephone number, gender, credentials such as user name and/or password that may be used to accesses platform 108 via application 110 or browser 112, etc.

In some embodiments, member profiles 218 may also store additional properties. These properties may be associated with types of tickets the members have previously purchased, member's location by tracking the location of client device 104, transaction history, interests, favorite stores, etc. With respect to the ticket property, the additional property in member profiles 218 may track whether a member is a season ticket holder, single ticket buyer, suite owner, etc.

As discussed above, in an embodiment, wallet management module 206 may include one or more values 208. In some embodiments, values 208 such as values 208B-E may be configured for members based on member profile 218 of a particular member. For example, configuration interface 113 may receive instructions that configure values 208B-E based on the properties in member profile 218A.

To configure values 208B-E based on the properties in member profile 218A, wallet management module 206 may include one or more rules 220. Rules 220 may be configured using configuration interface 113, in some embodiments. For example, configuration interface 113 may receive instructions that create rules 220 for one or more values 208B-E. In one example, rule 220 may be configured to determine a value of loaded value 208B based of a property in member profile 218A. For example, if a member property indicates that a member is a season ticket holder, rule 220 may set loaded value 208B to $10.00. Another example rule 220 may be configured to set discount value 208C based on a type of a ticket that was purchased by a member associated with member profile 218A. For example, discount value 208C may be set to 10% if a ticket is a season ticket and a value of 5% if a ticket is a single pay ticket.

In an embodiment, member profiles 218 may also store one or more tokens. Tokens may be generated by payment gateways 216 on behalf of one or more members. Further each payment gateway 216 may generate token that is specific to that payment gateway 216. For example, payment gateway 216A may generate a token that may be used by payment gateway 216A and not payment gateway 216B. In a further embodiment, each token may be specific to the payment information associated with the member and the payment information may be taken into account when payment gateway 216 generates the token. For example, payment gateway 216A may generate one token for credit card information associated with the member and a second token for debit card information associated with the same member. In an embodiment, platform 108 may access tokens from member profile 218 to conduct a transaction for a product on gateway 216 that is associated with that product. In an embodiment where member profile 218 includes multiple tokens, platform 108 may retrieve the token that corresponds to the payment information received from application 110 at point-of-sale module 204B.

In an embodiment, platform 108 may include or have an interface with tax automation module 224. Tax automation module 224 may determine tax that may be associated with a transaction associated with a product or a service. In some embodiments, tax automation module 224 may receive one or more parameters from mobile library 114, such as a location parameter. The location parameter may include the location of client device 104 when a customer uses client device 104 to conduct a transaction. The location parameter may include the location in various formats, such as geodetic coordinates, latitude/longitude coordinates, name of the city, state, etc. In an embodiment, transaction management module 210 may pass or transmit the location to tax automation module 224. Based on the location, tax automation module 224 may determine the tax that may be associated with the transaction.

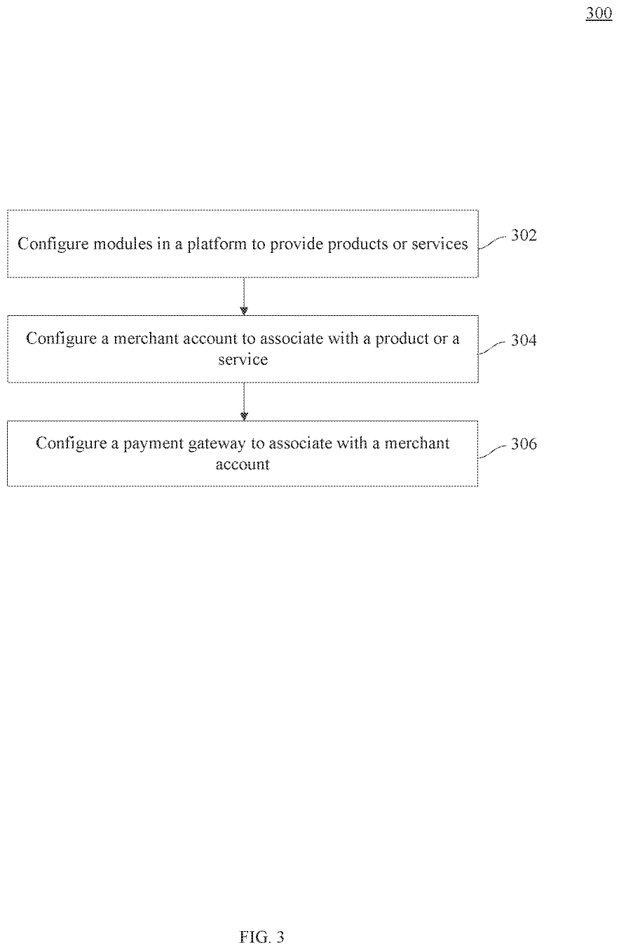

FIG. 3 is a flowchart of a method 300 for configuring a platform, according to an embodiment. Method 300 may be performed using hardware and/or software components described herein and in, e.g., FIGS. 1-2 and 7. Notably, one or more of the operations may be deleted, combined, or performed in a different order as appropriate. Further, additional operations may be performed at various stages of the method.

At operation 302, one or more modules that provide products or services are configured. For example, platform 108 may receive one or more configuration requests that identify products or services that may be sold using modules 202A-E. In an embodiment, a configuration request may configure a food and beverage module 202D to sell hamburgers, while another request may configure parking pass module 202B to sell a product, such as a parking pass. Once platform 108 receives the configuration request, platform 108 may configure modules 202A-E to provide one or more products or services to application 110 such that a buyer may perform a transaction that includes the one or more products or services.

At operation 304, merchant accounts are configured. For example, platform 108 may receive one or more configuration requests that configure merchant accounts 212 to process transactions for products or services configured in operation 302. For example, merchant account 212A may be configured to process parking pass transactions, merchant account 212B may be configured to processes ticket transactions for a sporting event,

At operation 306, a payment gateway is linked with a merchant account. For example, platform 108 receives one or more configuration requests that link one of merchant account 212 with payment gateway 216. For example, merchant account 212A may be linked with payment gateways 216B, and merchant account 212B may be linked with payment gateway 216A.

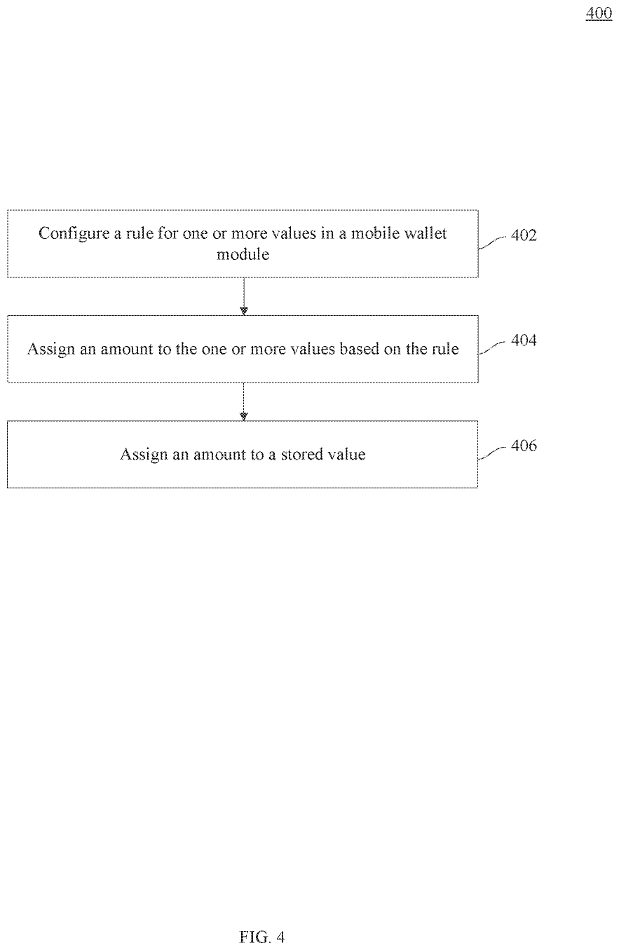

FIG. 4 is a flowchart of a method 400 for configuring a platform, according to an embodiment. Method 400 may be performed using hardware and/or software components described herein and in, e.g., FIGS. 1-2 and 7. Notably, one or more of the operations may be deleted, combined, or performed in a different order as appropriate. Further, additional operations may be performed at various stages of the method.

At operation 402, one or more rules are configured. For example, platform 108 may receive one or more configuration requests that configure one or more rules 220 in wallet management module 206.

At operation 404, one or more monetary value is assigned to one or more values. For example, platform 108 may assign values to loaded value 208B based on rules 220. For example, a loaded value 208B may be set to $10.00 based on one of rules 220 that indicates that a member is a season ticket holder. In another example, a discount value 208C is assigned 5% if a member is a single ticket holder. In another example, a sponsored value 208E is assigned $5.00 based on one of rules 220 that indicate that a “Chase” credit card is a sponsored card. In another example, a transaction may download an amount that may be stored in stored value 208A.

At operation 406, a stored value is configured. For example, wallet management module 210 may request for application 110 to transmit an amount to set for stored value 208A, if any.

Going back to FIG. 1, application 110 may execute on computing device 104 or may be accessed from platform 108 using browser 112. FIG. 5 is a block diagram 500 of application 110, according to an embodiment.

As illustrated in FIG. 5, application 110 may include a login interface 502. Login interface 502 may receive user credentials that application 110 may transmit to platform 108. Example credentials may be user identifier and a password, email address, credentials from another platform that may authenticate a user on behalf of platform 108, etc. Platform 108 may authenticate user credentials against user credentials stored in member profiles 218 discussed in FIG. 2, or transmit user credentials to another platform for authentication. Once authenticated, a user, such as a buyer or member may use application 110 to access platform 108 and perform transactions using platform 108.

In an embodiment, application 110 may include a mobile wallet interface 504. Mobile wallet interface 504 may request payment information from the user. Example payment information may be credit card information, debit card information, etc. Notably, the payment information is not stored in application 110 or in platform 108. Once application 110 receives payment information, application 110 may securely provide the payment information to payment gateways 216A-C. Once payment gateways 216A, 216B and/or 216C receive payment information from application 110, payment gateways 216A, 216B, and/or 216C may provide application 110 or platform 108 with one or more tokens. There may be one or more tokens from each payment gateway 216A, 216B and/or 216C. For example, if application 110 receives two types of payment information, such as two different credit cards, payment gateway 216A may generate two tokens, one token per credit card. In an embodiment, tokens may be securely stored in member profiles 218 of platform 108, memory storage associated with platform 108, or database 112.

In an embodiment, tokens from one or more gateways 216 may expire at predetermined time period or may be renewed from time to time. When one or more token, expire or about to expire, platform 108 may transmit a message to application 110 that indicates that the payment information may be renewed using one or more payment gateways 216 so that one or more payment gateways 216 may generate one or more renewed tokens.

In an embodiment, application 110 may request member properties stored in member profiles 218 and values 208 from wallet management module 206. For example, once platform 108 authenticates application 110, application 110 may request member profile 218A and values 208B-G that are associated with member profile 218A, as well as stored value 208A. In response to the request, application 110 may receive values 208 and display values 208 on mobile wallet interface 504 of application 110.

As discussed in FIG. 2, different values 208 may have different monetary values. Accordingly, application 110 may display different monetary values for values 208 in mobile wallet interface 504. For example, if member profile 218A indicates that a member is a season ticket holder, mobile wallet interface 504 may display $10.00 value associated with loaded value 208B. In another embodiment, mobile wallet interface 504 may display 10% off for merchandise and 20% off for food values associated with discount values 208C. In another embodiment, mobile wallet interface 504 may display a $20.00 value associated with loaded value 208B that is a discount associated with rule 220 to use at a particular event, such as a concert or a game. In yet another embodiment, mobile wallet interface 504 may be used to transfer tickets or discounts to other members. For example, when mobile profile 218A indicates that a member is a season ticket holder, mobile wallet interface 504 may display multiple tickets for the season. Once displayed, mobile wallet interface 504 may receive instructions from a member using client device 104 to transfer a ticket to a different member. The mobile wallet interface 504 may issue a request to platform 108 to transfer the ticket. Additionally, mobile wallet interface 504 may transfer one or more values 208 to another member. For example, mobile wallet interface 504 may receive a selection of a value associated with discount value 208C and issue a request to platform 108 to transfer the value in discount value 208C to another member. In response to the request, platform 108 may find the other member in platform 108, and transfer values 208 to another member.

In an embodiment, mobile wallet interface 504 may be used to conduct a transaction with point-of-sale module 204B for one or more products or services offered by modules 202. As discussed above, point-of-sale module 204B may be accessed from application 110 or from a standalone or hand-held computing device that executes point-of-sale module 204B. As part of the transaction, mobile wallet interface 504 may receive input to use one or more monetary values, such as $10.00 displayed via loaded value 208B, discount value 208C, etc., in the transaction.

In an embodiment, mobile wallet interface 504 within application 110 may transmit a request for transaction to point-of-sale module 204B. Included in the transaction may be a product or a service, or an identifier for a product or a service. Additionally, included in the transaction may be a member name or identifier that may map the member to one of member profiles 218. Additionally, the transaction may include payment information identifier, such as the last four digits of a credit card number, in order for platform 108 to select a token that corresponds to the payment information. In an embodiment, point-of-sale module 204B may transmit the transaction to platform 108.

As discussed above, platform 108 associates each product or service with one of merchant accounts 212 and one of payment gateways 216. Once platform 108 receives the transaction, platform 108 may use the product or service in the transaction to identify one of merchant account 212, and then use the one of merchant accounts to identify the corresponding one of payment gateways 216. Additionally, platform 108 may use the payment information identifier in the transaction to select a token from member profile 218 that corresponds to payment gateway 216 that may process the payment information.

In an embodiment, once platform 108 identifies one of merchant accounts 212 and one of payment gateways 216 that correspond to the product or the service in the transaction, platform 108 may process the transaction using the one of merchant accounts 212 and one of payment gateways 216.

In an embodiment, when platform 108 receives the transaction from point-of-sale module 204B, wallet management module 206 determines if the transaction indicates that one or more amounts in values 208A-E have been used. If one or more amounts in values 208A-E have been used, wallet management module 206 may adjust the amounts in values 208A-E accordingly. For example, if transaction uses $10.00 from loaded value 208B, then wallet management module 206 may adjust the amount in loaded value 208B by $10.00. Further, if wallet management module 206 determines that transfer value 208D has been used, wallet management module 206 may identify member profile 218 of the member that transferred the amount in transfer value 208D to the member that is associated with the transaction, and adjust the amount of the transferred value 208D for the identified member accordingly.

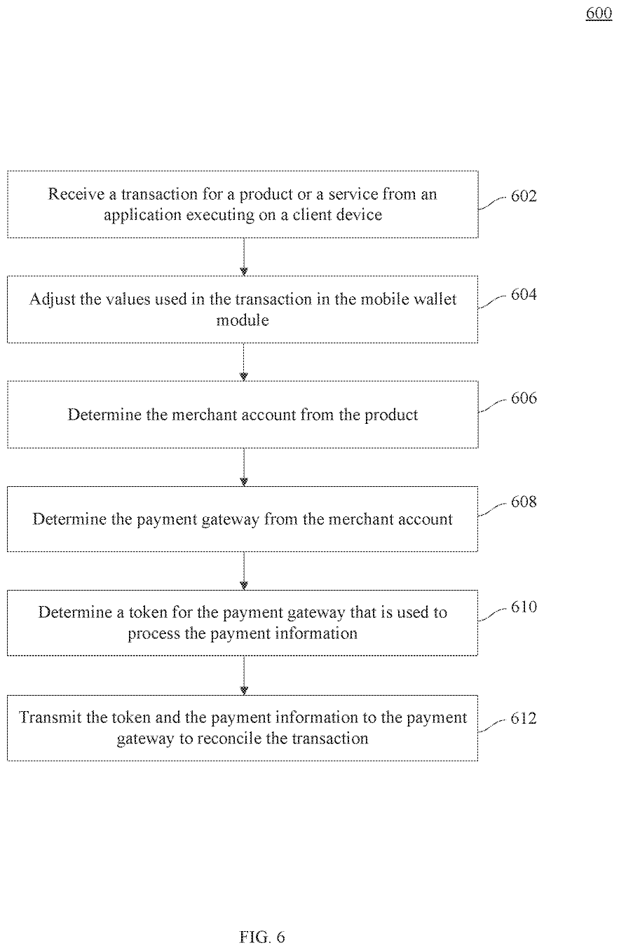

FIG. 6 is a flowchart of a method 600 for processing a transaction using the configured platform, according to an embodiment. Method 600 may be performed using hardware and/or software components described herein and in, e.g., FIGS. 1-2, 5 and 7. Notably, one or more of the operations may be deleted, combined, or performed in a different order as appropriate. Further, additional operations may be performed at various stages of the method.

At operation 602, a transaction is received. For example, platform 108 receives the transaction from point-of-sale module 204B. As discussed above, point-of-sale module 204B may receive the transaction from mobile wallet interface 504 of application 110 that executes on client device 104. In an embodiment, the transaction may be included in a message transmitted from point-of-sale module 204B to platform 108.

At operation 604, the values are reconciled. For example, the transaction may have used funds in loaded value 208B and wallet management module 206 may adjust the value in loaded value 208B by the amount used in the transaction, as adjusted by any applicable discount or reduction, such as the one or more values 208.

At operation 606, a merchant account is identified. For example, platform 108 may use the product or the service in the transaction to identify one of merchant account 212 that was configured to be associated with the product or the service.

At operation 608, a payment gateway is identified. For example, platform 108 may use one of merchant accounts 212 identified in operation 606 to determine one of payment gateways 216 associated with the one of merchant accounts 212.

At operation 610, a token is identified. For example, a member identifier, payment identifier, and/or the one of payment gateways 216 may be used to identify a token that may be used to process the payment information for the transaction. As discussed above, the member identifier may identify member profile 218 that corresponds to the member that was authenticated by application 110, the one of payment gateways 216 may identify one or more tokens that may process the transaction on the one of payment gateways 216 and the payment information may select the token with the credit card, debit card, etc., that application 110 indicates should be used to process the transaction.

At operation 612, the payment information and the token are transmitted to the payment gateway. For example, platform 108 may transmit the token and the payment information for the product or the service to the one of payment gateways identified in operation 608. As discussed above, because platform 108 stores tokens for corresponding gateways, platform 108 does not transmit the credit card, debit card, etc., information through platform 108.

In accordance with various embodiments of the disclosure, computer system 700, such as a computer and/or a server, includes a bus 702 or other communication mechanism for communicating information, which interconnects subsystems and components, such as a processing component 704 (e.g., processor, micro-controller, digital signal processor (DSP), graphics processing unit (GPU), etc.), a system memory component 706 (e.g., RAM), a static storage component 708 (e.g., ROM), a disk drive component 710 (e.g., magnetic or optical), a network interface component 712 (e.g., modem or Ethernet card), a display component or a display screen 714 (e.g., CRT or LCD), an input component 718 (e.g., keyboard, keypad, or virtual keyboard), a cursor control component 720 (e.g., mouse, pointer, or trackball), a location determination component 722 (e.g., a Global Positioning System (GPS) device as illustrated, a cell tower triangulation device, and/or a variety of other location determination devices known in the art), and/or a camera component 723. In one implementation, the disk drive component 710 may include a database having one or more disk drive components.

In accordance with embodiments of the disclosure, the computer system 700 performs specific operations by the processor 704 executing one or more sequences of instructions contained in the memory component 706, such as described herein with respect to the mobile communications devices, mobile devices, and/or servers. Such instructions may be read into the system memory component 706 from another computer readable medium, such as the static storage component 708 or the disk drive component 710. In other embodiments, hard-wired circuitry may be used in place of or in combination with software instructions to implement the disclosure.

Logic may be encoded in a computer readable medium, which may refer to any medium that participates in providing instructions to the processor 704 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that include the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 700. In various other embodiments of the disclosure, a plurality of the computer systems 700 coupled by a communication link 724 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components including software, hardware, and/or both without departing from the scope of the disclosure. Where applicable, the various hardware components and/or software components set forth herein may be separated into sub-components including software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system for configuring a platform, the system comprising:
one or more non-transitory computer-readable memories storing instructions; and
one or more hardware processors coupled to each of the non-transitory memories and adapted to configure the platform, the instructions that, when executed, comprise:
receiving a configuration for a plurality of items to be included in one or more modules associated with the platform from a configuration interface;
receiving a configuration for a first account to be associated with a first item in the plurality of items, and a second account to be associated with a second item in the plurality of items from the configuration interface;
receiving a configuration for a first gateway to be associated with a first account and a second gateway to be associated with the second account from the configuration interface;
configuring the platform to associate the first item with the first account and the first gateway and the second item with the second account and the second gateway; and
processing the first item and the second item using the configured platform.

2. The system of claim 1, wherein the instructions further comprise:
configuring the first item to be associated with a first module and the second item to be associated with the second module.

3. The system of claim 1, wherein the instructions further comprise:
configuring the first item to be associated with a first module and the second item to be associated with the first module.

4. The system of claim 1, wherein the instructions further comprise:
receiving a rule for configuring one or more values; and
assign an amount to the one or more values based on the rule.

5. The system of claim 1, wherein the instructions further comprise:
receiving an instruction for configuring one or more values based on a profile; and
identifying a property in the profile; and
configuring the one or more values based on the property in the profile.

6. The system of claim 1, wherein the instructions further comprise:
receiving a first token and a second token from the first gateway, wherein the first token and the second token are associated with information of a user associated with a profile;
selecting one of first token and the second token to process the first item and the second item; and
processing the first item and the second item using the selected token.

7. The system of claim 1, wherein the instructions further comprises:
receiving, from an application that communicates with the platform a value that is associated with a stored value in the platform;
wherein processing the first item using the configured platform comprises processing the first item using the stored value.

8. The system of claim 1, wherein the processing further comprises:
receiving a transaction associated with the first item;
adjusting the transaction using one or more values previously configured using on or more rules;
identifying the first account using the first item;
identifying the first gateway using the first account; and
processing the transaction using the first account and the first gateway.

9. A method for configuring a platform, the method comprising:
receiving, at the platform executing on a server, a configuration for a plurality of items to be included in one or more modules associated with the platform from a configuration interface;
receiving a configuration for a first account to be associated with a first item in the plurality of items, and a second account to be associated with a second item in the plurality of items from the configuration interface;
receiving a configuration for a first gateway to be associated with a first account and a second gateway to be associated with the second account from the configuration interface;
configuring the platform to associate the first item with the first account and the first gateway and the second item with the second account and the second gateway; and
processing the first item and the second item using the configured platform.

10. The method of claim 9, further comprising:
configuring the first item to be associated with a first module and the second item to be associated with the second module of the one or more modules.

11. The method of claim 9, further comprising:
configuring the first item to be associated with a first module and the second item to be associated with the first module.

12. The method of claim 9, further comprising:
receiving a rule for configuring one or more values; and
assign an amount to the one or more values based on the rule.

13. The method of claim 9, further comprising:
receiving an instruction for configuring one or more values based on a profile; and
identifying a property in the profile; and
configuring the one or more values based on the property in the profile.

14. The method of claim 9, further comprising:
receiving a first token and a second token from the first gateway, wherein the first token and the second token are associated with information of a user associated with a profile;
selecting one of first token and the second token to process the first item and the second item; and
processing the first item and the second item using the selected token.

15. The method of claim 9, further comprising:
processing the first item using the configured platform.

16. The method of claim 9, further comprising:
receiving a transaction associated with the first item;
adjusting the transaction using one or more values previously configured using on or more rules;
identifying the first account using the first item;
identifying the first gateway using the first account; and
processing the transaction using the first account and the first gateway.

17. A non-transitory machine readable medium having stored thereon instructions for performing a method that configures a platform, the method when executed by at least one machine, causes the machine to:
receive a configuration for a plurality of items to be included in one or more modules associated with the platform from a configuration interface;
receive a configuration for a first account to be associated with a first item in the plurality of items, and a second account to be associated with a second item in the plurality of items from the configuration interface;
receive a configuration for a first gateway to be associated with a first account and a second gateway to be associated with the second account from the configuration interface;
receive a configuration for at least one value to be associated with the first item and the second item;
configure the platform to associate the first item with the first account, the first gateway, and the at least one value and the second item with the second account, the second gateway, and the at least one value; and
process the first item and the second item using the configured platform.

18. The non-transitory machine readable medium of claim 17, wherein the instructions further cause the machine to:
configure the first item to be associated with a first module of the one or more modules and the second item to be associated with the second module of the one or more modules.

19. The non-transitory machine readable medium of claim 17, wherein the instructions further cause the machine to:
configure the first item to be associated with a first module and the second item to be associated with the first module.

20. The non-transitory machine readable medium of claim 17, wherein the instructions further cause the machine to:
receive a rule for configuring one or more values; and
assign an amount to the one or more values based on the rule.
